(19) United States
(12) Patent Application Publication
(10) Pub. No.: US 2025/0216714 A1
(43) Pub. Date: Jul. 3, 2025

(54) POLYMER-DISPERSED LIQUID CRYSTAL FILM, OPTICAL FILM SET, AND METHOD FOR PRODUCING POLYMER-DISPERSED LIQUID CRYSTAL FILM

(71) Applicant: NITTO DENKO CORPORATION, Ibaraki-shi, Osaka (JP)

(72) Inventors: Jin YOSHIKAWA, Ibaraki-shi, Osaka (JP); Mariko HIRAI, Ibaraki-shi, Osaka (JP); Minoru MIYATAKE, Ibaraki-shi, Osaka (JP)

(21) Appl. No.: 18/850,656

(22) PCT Filed: Mar. 23, 2023
(86) PCT No.: PCT/JP2023/011467

§ 371 Date: Sep. 25, 2024

(30) Foreign Application Priority Data
Mar. 29, 2022 (JP) 2022-052900

(51) Int. Cl. G02F 1/1334; G02F 1/1335

(52) U.S. Cl. CPC G02F 1/1334; G02F 1/1335

(57) ABSTRACT

The present invention provides a polymer dispersed liquid crystal film capable of changing a haze under a no voltage applied state or under a state in which an applied voltage is kept constant. The polymer dispersed liquid crystal film of the present invention includes in this order: a first transparent conductive film; a polymer dispersed liquid crystal layer including a polymer matrix and droplets of a liquid crystal compound dispersed in the polymer matrix; and a second transparent conductive film. The polymer dispersed liquid crystal film exhibits a lower haze under a voltage applied state than under a no voltage applied state. The haze in the no voltage applied state exhibits polarization dependency.

### TECHNICAL FIELD

The present invention relates to a polymer dispersed liquid crystal film, an optical film set, and a method of producing a polymer dispersed liquid crystal film.

### BACKGROUND ART

In recent years, a light control film that exhibits various appearances in accordance with the application state of a voltage has been applied to various applications including display bodies, such as an advertisement and a guide board, and a smart window.

A polymer dispersed liquid crystal (hereinafter sometimes referred to as “PDLC”) film including a PDLC layer between a pair of transparent electrode layers is one type of light control film. The film can switch a state in which light is scattered (scattering state) and a state in which light is transmitted (non-scattering state or transparent state) by switching a voltage applied state and a no voltage applied state. Specifically, the PDLC layer includes a polymer matrix and droplets of a liquid crystal compound (liquid crystal droplets) dispersed in the polymer matrix. The liquid crystal droplets serve as scattering particles by virtue of, for example, a difference in refractive index between the liquid crystal compound in each of the liquid crystal droplets and the polymer matrix, and can thus cause light scattering (for example, Patent Literature 1).

### CITATION LIST

### Patent Literature

[PTL 1] JP 2002-189123 A

### SUMMARY OF INVENTION

### Technical Problem

The above-mentioned PDLC film can exhibit two appearances, that is, a cloudy appearance (scattering state) and a transparent appearance (non-scattering state) by switching a state in which an operating voltage is applied to the PDLC layer and a no voltage applied state. In addition, the degree of scattering (as a result, a haze) can be changed by changing the magnitude of an applied voltage. However, there is still no PDLC film capable of changing a haze under a no voltage applied state or under a state in which an applied voltage is kept constant.

A primary object of the present invention is to provide a PDLC film capable of changing a haze under a no voltage applied state or under a state in which an applied voltage is kept constant.

### Solution to Problem

According to one aspect of the present invention, there is provided a polymer dispersed liquid crystal film, including in this order: a first transparent conductive film; a polymer dispersed liquid crystal layer including a polymer matrix and droplets of a liquid crystal compound dispersed in the polymer matrix; and a second transparent conductive film, wherein the polymer dispersed liquid crystal film exhibits a lower haze under a voltage applied state than under a no voltage applied state, and wherein the haze in the no voltage applied state exhibits polarization dependency.

In one embodiment, in the polymer dispersed liquid crystal film, under the no voltage applied state, a maximum value of a difference between a haze at a time when linearly polarized light vibrating in a first direction is caused to enter the polymer dispersed liquid crystal film perpendicularly to a main surface thereof and a haze at a time when linearly polarized light vibrating in a second direction perpendicular to the first direction is caused to enter the polymer dispersed liquid crystal film perpendicularly to the main surface is 10% or more.

In one embodiment, the liquid crystal compound includes a nematic liquid crystal compound.

In one embodiment, a polymer matrix-forming resin for forming the polymer matrix includes at least one kind selected from a urethane-based resin, an acrylic resin, and a polyvinyl alcohol-based resin.

According to another aspect of the present invention, there is provided an optical film set, including: the polymer dispersed liquid crystal film; and a polarizer arranged on one side of the polymer dispersed liquid crystal film.

According to yet another aspect of the present invention, there is provided a method of producing a polymer dispersed liquid crystal film, including in this order: applying, to a surface of a release liner, an application liquid containing a liquid crystal compound, a polymer matrix-forming resin, and a solvent to form an applied layer; drying the applied layer to form a polymer dispersed liquid crystal layer including a polymer matrix and droplets of the liquid crystal compound dispersed in the polymer matrix on the release liner; stretching the polymer dispersed liquid crystal layer; obtaining a laminate of the polymer dispersed liquid crystal layer and a first transparent conductive film; and laminating a second transparent conductive film on the polymer dispersed liquid crystal layer on an opposite side to a side on which the first transparent conductive film is arranged.

In one embodiment, a stretching ratio of the polymer dispersed liquid crystal layer is more than 1.0 times and 5 times or less.

In one embodiment, the liquid crystal compound includes a nematic liquid crystal compound.

In one embodiment, a polymer matrix-forming resin for forming the polymer matrix includes at least one kind selected from a urethane-based resin, an acrylic resin, and a polyvinyl alcohol-based resin.

### Advantageous Effects of Invention

According to the present invention, there is provided the PDLC film capable of changing a haze under the no voltage applied state or under the state in which an applied voltage is kept constant by changing the polarization state of incident light and the like.

### BRIEF DESCRIPTION OF DRAWINGS

FIG. 1 is a schematic sectional view of a PDLC film according to one embodiment of the present invention.

FIG. 2(a) is a schematic view for illustrating a refractive index ellipsoid of a liquid crystal compound in a PDLC layer in a voltage applied state. FIG. 2(b) is a schematic view for illustrating the refractive index ellipsoid of the liquid crystal compound aligned in an oblique direction.

FIG. 3 are each a schematic view for illustrating a method of producing a PDLC film according to one embodiment of the present invention.

FIG. 4 shows optical microscope observation images of PDLC films obtained in Examples and Comparative Examples.

FIG. 5 shows a SEM image of a cut surface obtained by cutting the PDLC film obtained in Example 1-3 in a direction parallel to a stretching direction.

FIG. 6 shows a SEM image of a cut surface obtained by cutting the PDLC film obtained in Example 1-3 in a direction perpendicular to the stretching direction.

FIG. 7 shows polarization microscope observation images of the PDLC films obtained in Examples and Comparative Example.

FIG. 8A is a VH curve of each of the PDLC films obtained in Examples and Comparative Example.

FIG. 8B is a graph for showing a relationship between a haze of each of the PDLC films obtained in Examples and Comparative Example and a voltage per unit thickness.

FIG. 9 is a VH curve of the PDLC film obtained in Comparative Example 1.

FIG. 10 is a VH curve of the PDLC film obtained in Example 1-1.

FIG. 11 is a VH curve of the PDLC film obtained in Example 1-2.

FIG. 12 is a VH curve of the PDLC film obtained in Example 1-3.

### DESCRIPTION OF EMBODIMENTS

Preferred embodiments of the present invention are described below. However, the present invention is not limited to these embodiments. In this description, the expression “from . . . to . . . ” representing a numerical range includes the upper limit and lower limit numerical values thereof.

### A. Polymer Dispersed Liquid Crystal Film

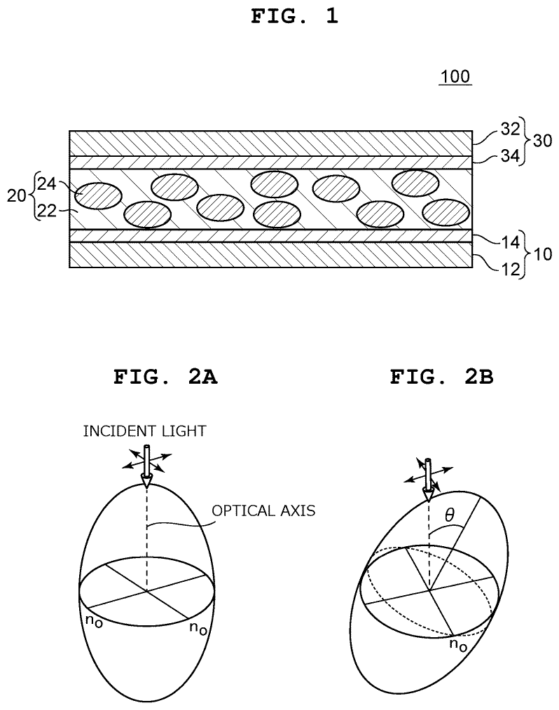

FIG. 1 is a schematic sectional view of a PDLC film according to one embodiment of the present invention. A PDLC film 100 includes in this order: a first transparent conductive film 10; a PDLC layer 20 including a polymer matrix 22 and droplets 24 of a liquid crystal compound dispersed in the polymer matrix 22; and a second transparent conductive film 30. The PDLC layer 20 and the first transparent conductive film 10 or the second transparent conductive film 30 may be bonded to each other via an adhesion layer (not shown) or may be directly laminated on each other without via the adhesion layer. The adhesion layer may be formed of an adhesive composition or a pressure-sensitive adhesive composition.

The above-mentioned PDLC film is in a so-called normal mode and exhibits a lower haze under a voltage applied state than under a no voltage applied state. Specifically, under a state in which a voltage is applied to the PDLC layer, the liquid crystal compound is aligned in an electric field direction, and the difference between the refractive index of the liquid crystal compound and the refractive index of the polymer matrix is reduced, with the result that the PDLC film can be brought into a low haze state (transparent state). Meanwhile, under a no voltage applied state, the alignment property of the liquid crystal compound is low, and the liquid crystal droplets function as scattering particles in the PDLC layer, with the result that the PDLC film can be brought into a high haze state (scattering state).

In addition, the haze of the PDLC film in the no voltage applied state exhibits polarization dependency. Herein, the expression “haze exhibits polarization dependency” means that, when linearly polarized light is caused to enter the PDLC film perpendicularly to a main surface thereof, the haze varies depending on the vibration direction of the linearly polarized light.

The amount of change in haze depending on the vibration direction of the incident linearly polarized light may be appropriately set in accordance with the applications and the like of the PDLC film. In one embodiment, under the no voltage applied state, the maximum value of a difference between the haze at the time when linearly polarized light vibrating in a first direction is caused to enter the PDLC film perpendicularly to a main surface thereof and the haze at the time when linearly polarized light vibrating in a second direction perpendicular to the first direction is caused to enter the film perpendicularly to the main surface is, for example, 10% or more, preferably from 20% to 90%, more preferably from 50% to 90%.

The haze at the time when non-polarized light (natural light) is caused to enter the PDLC film in the no voltage applied state (scattering state) is, for example, more than 40%, preferably from 45% to 95%, more preferably from 50% to 90%. In addition, a total light transmittance at the time when non-polarized light is caused to enter the PDLC film in the no voltage applied state (scattering state) is, for example, 60% or more, preferably from 65% to 95%, more preferably from 75% to 95%. The total light transmittance may be measured in accordance with JIS K 7361.

The haze at the time when non-polarized light is caused to enter the PDLC film in the voltage applied state (transparent state) is, for example, 40% or less, preferably from 2% to 30%, more preferably from 2% to 20%, still more preferably from 2% to 10%. In addition, a total light transmittance at the time when non-polarized light is caused to enter the PDLC film in the voltage applied state (transparent state) is, for example, 60% or more, preferably from 65% to 95%, more preferably from 75% to 95%.

A voltage to be applied to the PDLC film at the time of the application of a voltage is a voltage (operating voltage) with which the PDLC film can be operated, and may be, for example, from 5 V to 200 V, preferably from 10 V to 100 V. As used herein, the “haze in the voltage applied state” means, unless otherwise specified, a haze at the time when the operating voltage is applied to the PDLC film, and may be a haze at the time of the application of a voltage of, for example, 10 V or more, 20 V or more, or 30 V or more. The voltage to be applied may be an AC voltage or a DC voltage. Examples of the waveform of the AC voltage include a sinusoidal AC voltage waveform, a rectangular AC voltage waveform, and a triangular AC voltage waveform.

The thickness of the PDLC film is, for example, from 30 μm to 250 μm, preferably from 50 μm to 150 μm.

### A-1. First Transparent Conductive Film

Any appropriate conductive film may be used as the first transparent conductive film as long as the effects of the present invention are obtained.

The first transparent conductive film 10 illustrated in FIG. 1 includes a first transparent substrate 12 and a first transparent electrode layer 14 arranged on one side thereof (on the PDLC layer 20 side). The first transparent conductive film may further include any appropriate functional layer as required, though the layer is not shown. For example, the first transparent conductive film may include a hard coat layer on one surface, or each of both surfaces, of the first transparent substrate. In addition, for example, the first transparent conductive film may include a refractive index-adjusting layer between the first transparent substrate and the first transparent electrode layer.

The surface resistance value of the first transparent conductive film is preferably from 1Ω/□ to 1,000Ω/□, more preferably from 5Ω/□ to 300Ω/□, still more preferably from 10Ω/□ to 200Ω/□.

The haze of the first transparent conductive film is preferably 20% or less, more preferably 10% or less, still more preferably from 0.1% to 10%.

The total light transmittance of the first transparent conductive film is preferably 30% or more, more preferably 60% or more, still more preferably 80% or more.

The first transparent conductive film may be optically isotropic or optically anisotropic. As used herein, the “optically isotropic” means that an in-plane retardation Re(550) is from 0 nm to 10 nm and a thickness direction retardation Rth(550) is from −10 nm to +10 nm. “Re(λ)” is an in-plane retardation measured with light having a wavelength of λ nm at 23° C. The Re(λ) is determined by the formula: Re(λ)=(nx−ny)×d, where “d” (nm) represents the thickness of a layer (film). In addition, “Rth(λ)” is a thickness direction retardation measured with light having a wavelength of A nm at 23° C. The Rth(λ) is determined by the formula: Rth(λ)=(nx−nz)×d, where “d” (nm) represents the thickness of a layer (film). Herein, the “nx” represents a refractive index in a direction in which a refractive index in a plane becomes maximum (i.e., a slow axis direction), the “ny” represents a refractive index in a direction perpendicular to the slow axis in the plane (i.e., a fast axis direction), and the “nz” represents a refractive index in a thickness direction.

### A-1-1. First Transparent Substrate

The first transparent substrate may be formed by using any appropriate material. A polymer substrate, such as a film or a plastic substrate, is preferably used as the forming material.

The polymer substrate is typically a polymer film containing a thermoplastic resin as a main component. Examples of the thermoplastic resin include: a cycloolefin-based resin such as polynorbornene; an acrylic resin; a polyester-based resin such as polyethylene terephthalate; a polycarbonate resin; and a cellulose-based resin. Of those, a polynorbornene resin, a polyethylene terephthalate resin, or a polycarbonate resin may be preferably used. The thermoplastic resins may be used alone or in combination thereof.

The thickness of the first transparent substrate is preferably from 20 μm to 200 μm, more preferably from 30 μm to 100 μm.

### A-1-2. First Transparent Electrode Layer

The first transparent electrode layer may be formed by using a metal oxide, such as an indium tin oxide (ITO), zinc oxide (ZnO), or tin oxide (SnO₂). In this case, the metal oxide may be an amorphous metal oxide or a crystallized metal oxide. The first transparent electrode layer may be formed of a metal nanowire such as a silver nanowire (AgNW), a carbon nanotube (CNT), an organic conductive film, a metal layer, or a laminate thereof. The first transparent electrode layer may be patterned into a desired shape in accordance with purposes.

The thickness of the first transparent electrode layer is preferably from 0.01 μm to 0.20 μm, more preferably from 0.01 μm to 0.1 μm.

The first transparent electrode layer is arranged on one surface of the first transparent substrate by, for example, sputtering. After the formation of a metal oxide layer by the sputtering, the layer may be crystallized by annealing. The annealing is performed by, for example, thermally treating the layer at from 120° C. to 300° C. for from 10 minutes to 120 minutes.

### A-1-3. Hard Coat Layer

The hard coat layer may impart scratch resistance and surface smoothness to the PDLC film and contribute to an improvement in handleability thereof. The hard coat layer may be, for example, a cured layer of any appropriate UV-curable resin. Examples of the UV-curable resin include an acrylic resin, a silicone-based resin, a polyester-based resin, a urethane-based resin, an amide-based resin, and an epoxy-based resin.

The hard coat layer may be formed by applying an application liquid containing a monomer or an oligomer of a UV-curable resin, and a photopolymerization initiator and the like as required to the first transparent substrate, followed by drying, and curing the dried applied layer by irradiation with UV light.

The thickness of the hard coat layer is preferably from 0.4 μm to 40 μm, more preferably from 1 μm to 10 μm.

### A-1-4. Refractive Index-Adjusting Layer

The refractive index-adjusting layer may suppress interface reflection between the first transparent substrate and the first transparent electrode layer. The refractive index-adjusting layer may be formed of a single layer, or may be a laminate of two or more layers.

The refractive index of the refractive index-adjusting layer is preferably from 1.3 to 1.8, more preferably from 1.35 to 1.7, still more preferably from 1.40 to 1.65. Thus, the interface reflection between the first transparent substrate and the first transparent electrode layer can be suitably reduced.

The refractive index-adjusting layer is formed from inorganic matter, organic matter, or a mixture of the inorganic matter and the organic matter. Examples of a material for forming the refractive index-adjusting layer include: inorganic matter, such as NaF, Na₃AlF₆, LiF, MgF₂, CaF₂, SiO₂, LaF₃, CeF₃, Al₂O₃, TiO₂, Ta₂O₅, ZrO₂, ZnO, ZnS, or SiOₓ (“x” represents a number of 1.5 or more and less than 2); and organic matter, such as an acrylic resin, an epoxy resin, a urethane resin, a melamine resin, an alkyd resin, or a siloxane-based polymer. In particular, a thermosetting resin formed of a mixture of a melamine resin, an alkyd resin, and an organic silane condensate is preferably used as the organic matter.

The refractive index-adjusting layer may contain nano-fine particles having an average particle diameter of from 1 nm to 100 nm. The incorporation of the nano-fine particles into the refractive index-adjusting layer can facilitate the adjustment of the refractive index of the refractive index-adjusting layer itself.

The content of the nano-fine particles in the refractive index-adjusting layer is preferably from 0.1 wt % to 90 wt %. In addition, the content of the nano-fine particles in the refractive index-adjusting layer is more preferably from 10 wt % to 80 wt %, still more preferably from 20 wt % to 70 wt %.

Examples of an inorganic oxide for forming the nano-fine particles include silicon oxide (silica), hollow nanosilica, titanium oxide, aluminum oxide, zinc oxide, tin oxide, zirconium oxide, and niobium oxide. Of those, silicon oxide (silica), titanium oxide, aluminum oxide, zinc oxide, tin oxide, zirconium oxide, and niobium oxide are preferred. Those inorganic oxides may be used alone or in combination thereof.

The thickness of the refractive index-adjusting layer is preferably from 10 nm to 200 nm, more preferably from 20 nm to 150 nm, still more preferably from 30 nm to 130 nm. When the thickness of the refractive index-adjusting layer is excessively small, the layer hardly becomes a continuous film. In addition, when the thickness of the refractive index-adjusting layer is excessively large, there is a tendency that the transparency of the PDLC film in a transparent state reduces or a crack is liable to occur.

The refractive index-adjusting layer may be formed by, for example, a coating method, such as a wet method, a gravure coating method, or a bar coating method, a vacuum deposition method, a sputtering method, or an ion plating method through use of the above-mentioned material.

### A-2. Second Transparent Conductive Film

The second transparent conductive film 30 illustrated in FIG. 1 includes a second transparent substrate 32 and a second transparent electrode layer 34 arranged on one side thereof (on the PDLC layer 20 side). The second transparent conductive film may further include any appropriate functional layer as required, though the layer is not shown. For example, the second transparent conductive film may include a hard coat layer on one surface, or each of both surfaces, of the second transparent substrate. In addition, for example, the second transparent conductive film may include a refractive index-adjusting layer between the second transparent substrate and the second transparent electrode layer.

The same descriptions as those of the first transparent substrate and the first transparent electrode layer may be applied to the second transparent substrate and the second transparent electrode layer, respectively. In addition, the hard coat layer and the refractive index-adjusting layer are as described in the section A-1 regarding the first transparent conductive film. The second transparent conductive film may have the same configuration as that of the first transparent conductive film, or may have a configuration different therefrom.

### A-3. Polymer Dispersed Liquid Crystal Layer

The PDLC layer 20 includes the polymer matrix 22 serving as a base material and the droplets 24 of a liquid crystal compound (liquid crystal droplets) dispersed in the polymer matrix 22.

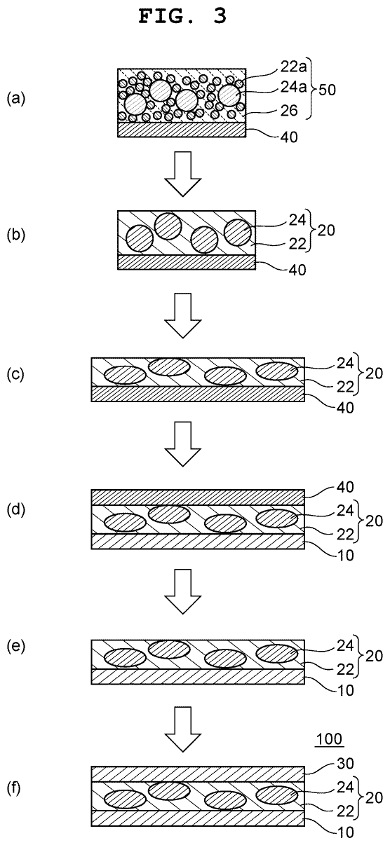

Although not intended to limit the present invention in any way, the presumed mechanism by which the haze in the no voltage applied state exhibits polarization dependency in the PDLC film according to the embodiment of the present invention is described below with reference to FIG. 2. FIG. 2(a) is a schematic view for illustrating a refractive index ellipsoid of the liquid crystal compound in the PDLC layer in the voltage applied state. Under the voltage applied state, the liquid crystal compound is aligned substantially perpendicularly to the main surface of the PDLC film so that the optical axis is parallel to the electric field direction. In this case, the cross-section of the refractive index ellipsoid of the liquid crystal compound perpendicular to the traveling direction of incident light has a circular shape, and design is made so that a normal light refractive index (no) and the refractive index of the polymer matrix are identical to each other or close to each other. Thus, scattering of transmitted light is suppressed irrespective of the polarization state of the incident light, and the PDLC film is brought into a transparent state. Meanwhile, in the PDLC layer in the no voltage applied state, the liquid crystal compound as a whole is in a state of being gently aligned in an oblique direction with respect to the main surface. FIG. 2(b) is a schematic view for illustrating the refractive index ellipsoid of the liquid crystal compound aligned in the oblique direction. The cross-section of the refractive index ellipsoid of the liquid crystal compound perpendicular to the traveling direction of the incident light has an elliptical shape, and the refractive index of a minor axis thereof is not changed from the normal light refractive index (no) while the refractive index of a major axis thereof becomes larger than the normal light refractive index. As a result, scattering of linearly polarized light vibrating in a direction parallel to a minor axis direction is suppressed while linearly polarized light vibrating in a direction parallel to a major axis direction is scattered. Thus, with the PDLC layer containing the liquid crystal compound aligned in the oblique direction, a scattering property (as a result, a haze) becomes maximum when linearly polarized light vibrating in a direction parallel to the major axis direction is caused to enter the PDLC film under the no voltage applied state, and the scattering property becomes minimum when linearly polarized light vibrating in a direction parallel to the minor axis direction is caused to enter the PDLC film under the no voltage applied state. In addition, the scattering property at the time when non-polarized light is caused to enter the PDLC film becomes an intermediate state therebetween. Thus, the PDLC film according to the embodiment of the present invention may exhibit different hazes depending on the polarization state of the incident light.

The shape of each of the liquid crystal droplets is typically non-spherical. Specifically, the liquid crystal droplets may each have a flat shape in which a length in a thickness direction is shorter than a length in a horizontal direction. It is conceived that this shape results from the stretching of the PDLC layer in a method of producing a PDLC film described later. The particle diameters of the liquid crystal droplets may vary depending on the stretching ratio and the like. The length of the major axis of each of the liquid crystal droplets in a sectional SEM image of the PDLC layer in a direction parallel to the stretching direction may be, for example, from 0.3 μm to 27 μm, and the length of the minor axis thereof may be, for example, from 0.2 μm to 9 μm. In addition, the length of the major axis of each of the liquid crystal droplets in a sectional SEM image of the PDLC layer in a direction perpendicular to the stretching direction may be, for example, from 0.3 μm to 9 μm, and the length of the minor axis thereof may be, for example, from 0.1 μm to 9 μm. In one embodiment, the flatness of each of the liquid crystal droplets may be, for example, less than 0.85, preferably from 0.1 to 0.4. The flatness may be calculated by determining a flatness (maximum length in the thickness direction/maximum length in the horizontal direction) of each of 20 or more liquid crystal droplets in a microscope observation image of a cross-section perpendicular to the stretching direction of the PDLC layer and taking the average thereof.

Any appropriate liquid crystal compound may be used as the liquid crystal compound. A liquid crystal compound having preferably a birefringence Δn (=ne−no; ne represents the refractive index of a molecule of the liquid crystal compound in a major axis direction, and no represents the refractive index of the molecule of the liquid crystal compound in a minor axis direction) of from 0.05 to 0.50, more preferably a birefringence Δn of from 0.10 to 0.45 at a wavelength of 589 nm is used. The liquid crystal compounds may be used alone or in combination thereof.

The dielectric anisotropy of the liquid crystal compound may be positive or negative. The liquid crystal compound may be, for example, a nematic, smectic, or cholesteric liquid crystal compound. From the viewpoint of suitably obtaining the effects of the present invention, a nematic liquid crystal compound is preferably used.

Examples of the nematic liquid crystal compound include a biphenyl-based compound, a phenyl benzoate-based compound, a cyclohexylbenzene-based compound, an azoxybenzene-based compound, an azobenzene-based compound, an azomethine-based compound, a terphenyl-based compound, a biphenyl benzoate-based compound, a cyclohexylbiphenyl-based compound, a phenylpyridine-based compound, a cyclohexylpyrimidine-based compound, a cholesterol-based compound, and a fluorine-based compound.

The polymer matrix is subjected to stretching treatment after the formation of the PDLC layer as described later, and is hence typically formed of a thermoplastic resin. A polymer matrix-forming resin may be appropriately selected in accordance with, for example, a light transmittance, the refractive index of the liquid crystal compound, and adhesiveness to the transparent conductive film. For example, a water-soluble resin or a water-dispersible resin, such as a urethane-based resin, a polyvinyl alcohol-based resin, a polyethylene-based resin, a polypropylene-based resin, or an acrylic resin, may be preferably used. Of those, a urethane-based resin, an acrylic resin, and a polyvinyl alcohol-based resin are preferred because of excellent adhesiveness to the transparent conductive film. The polymer matrix-forming resins may be used alone or in combination thereof.

The PDLC layer may further contain any appropriate optional component as required. Examples of such optional component include a surfactant, a leveling agent, a cross-linking agent, and a dispersion stabilizer.

The content ratio of the liquid crystal compound in the PDLC layer is, for example, from 30 wt % to 70 wt %, preferably from 35 wt % to 65 wt %, more preferably from 40 wt % to 60 wt %.

The content of the polymer matrix in the PDLC layer is, for example, from 30 wt % to 70 wt %, preferably from 35 wt % to 65 wt %, more preferably from 40 wt % to 60 wt %.

The total content ratio of the polymer matrix and the liquid crystal compound in the PDLC layer is, for example, 90 wt % or more, preferably 95 wt % or more, and is, for example, 100 wt % or less, preferably 99 wt % or less.

The thickness of the PDLC layer is typically from 2 μm to 40 μm, preferably from 3 μm to 35 μm, more preferably from 4 μm to 30 μm.

B. Method of producing Polymer Dispersed Liquid Crystal Film

According to one aspect of the present invention, there is provided a method of producing a polymer dispersed liquid crystal (PDLC) film. The method of producing a PDLC film according to an embodiment of the present invention includes in this order:
(Step I) applying, to a surface of a release liner, an application liquid containing a liquid crystal compound, a polymer matrix-forming resin, and a solvent to form an applied layer;
(Step II) drying the applied layer to form a polymer dispersed liquid crystal layer including a polymer matrix and droplets of the liquid crystal compound dispersed in the polymer matrix on the release liner;
(Step III) stretching the polymer dispersed liquid crystal layer;
(Step IV) obtaining a laminate of the polymer dispersed liquid crystal layer and a first transparent conductive film; and
(Step V) laminating a second transparent conductive film on the polymer dispersed liquid crystal layer on an opposite side to a side on which the first transparent conductive film is arranged.

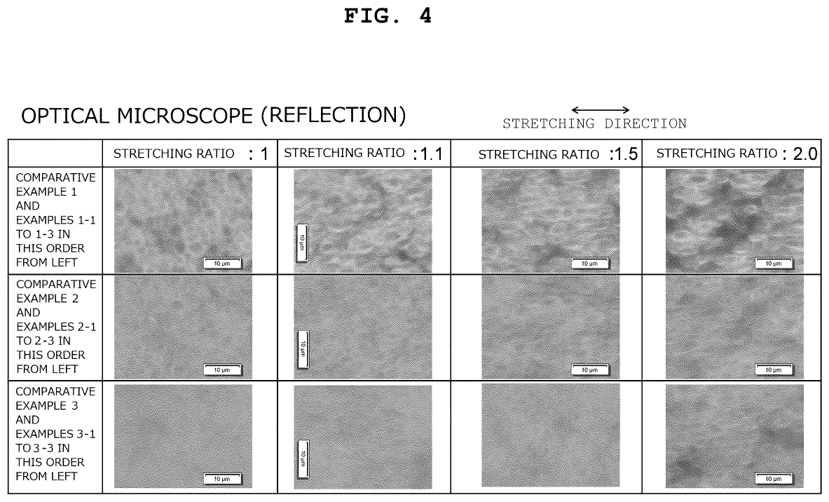

Each step is specifically described below with reference to FIG. 3.

### B-1. Step I

In the step I, as illustrated in FIG. 3(a), an application liquid containing a liquid crystal compound, a polymer matrix-forming resin, and a solvent is applied to the surface of a release liner 40 to form an applied layer 50.

The application liquid is preferably an emulsion (hereinafter sometimes referred to as “emulsion application liquid”) in which liquid crystal particles each containing the liquid crystal compound are dispersed in the solvent. In one embodiment, the application liquid is an emulsion application liquid in which polymer matrix-forming resin particles 22a and liquid crystal particles 24a each containing the liquid crystal compound are dispersed in a solvent 26. The emulsion application liquid may contain any appropriate additive in accordance with purposes.

Water or a mixed solvent of water and a water-miscible organic solvent may be preferably used as the solvent. Examples of the water-miscible organic solvent include C1 to C3 alcohols, acetone, and DMSO. The liquid crystal compound and the polymer matrix-forming resin are as described in the section A-3. Examples of the any appropriate additive include a dispersant, a leveling agent, and a cross-linking agent.

The content ratio of the liquid crystal compound in the solid content of the application liquid may be, for example, from 30 wt % to 70 wt %, preferably from 35 wt % to 65 wt %, more preferably from 40 wt % to 60 wt %.

The content ratio of the polymer matrix-forming resin in the solid content of the application liquid may be, for example, from 30 wt % to 70 wt %, preferably from 35 wt % to 65 wt %, more preferably from 40 wt % to 60 wt %.

A weight ratio between the content of the liquid crystal compound and the content of the polymer matrix-forming resin in the application liquid may be, for example, from 30:70 to 70:30, preferably from 35:65 to 65:35, more preferably from 40:60 to 60:40. In addition, the total content ratio of the polymer matrix-forming resin and the liquid crystal compound in the solid content of the application liquid may be, for example, from 90 wt % to 99.9 wt %, preferably from 95 wt % to 99.9 wt %.

The average particle diameter of the liquid crystal particles is preferably 0.3 μm or more, more preferably 0.4 μm or more. In addition, the average particle diameter of the liquid crystal particles is preferably 9 μm or less, more preferably 8 μm or less. When the average particle diameter of the liquid crystal particles falls within the ranges, the average particle diameter of the liquid crystal droplets in the PDLC layer can be set within a desired range. The average particle diameter of the liquid crystal particles is a volume-average particle diameter.

The average particle diameter of the liquid crystal particles preferably has a relatively narrow particle size distribution. The coefficient of variation (CV value) of the average particle diameter of the liquid crystal particles may be, for example, less than 0.40, and may be preferably 0.35 or less, more preferably 0.30 or less. In one embodiment, an emulsion application liquid substantially free of any liquid crystal particles each having a particle diameter of less than 0.3 μm or more than 9 μm (e.g., an emulsion application liquid in which the ratio of the volume of liquid crystal particles each having a particle diameter of less than 0.3 μm or more than 9 μm to the total volume of the liquid crystal particles is 10% or less) may be used.

The average particle diameter of the polymer matrix-forming resin particles is preferably from 10 nm to 500 nm, more preferably from 30 nm to 300 nm, still more preferably from 50 nm to 200 nm. Two or more kinds of resin particles containing different kinds of resins and/or having different average particle diameters may be used. The average particle diameter of the polymer matrix-forming resin particles means a volume-average median diameter, and may be measured with a dynamic light scattering-type particle size distribution-measuring apparatus.

Examples of the dispersant may include an anionic surfactant, a cationic surfactant, an amphoteric surfactant, and a nonionic surfactant. The content ratio of the dispersant is preferably from 0.05 part by weight to 10 parts by weight, more preferably from 0.1 part by weight to 1 part by weight with respect to 100 parts by weight of the emulsion application liquid.

Examples of the leveling agent may include an acrylic leveling agent, a fluorine-based leveling agent, and a silicone-based leveling agent. The content ratio of the leveling agent is preferably from 0.05 part by weight to 10 parts by weight, more preferably from 0.1 part by weight to 1 part by weight with respect to 100 parts by weight of the emulsion application liquid.

Examples of the cross-linking agent may include an aziridine-based cross-linking agent and an isocyanate-based cross-linking agent. The content ratio of the cross-linking agent is preferably from 0.5 part by weight to 10 parts by weight, more preferably from 0.8 part by weight to 5 parts by weight with respect to 100 parts by weight of the emulsion application liquid.

The emulsion application liquid may be prepared by, for example, mixing a resin emulsion containing polymer matrix-forming resin particles or a resin solution containing a polymer matrix-forming resin, a liquid crystal emulsion containing liquid crystal particles, and any appropriate additive (e.g., a dispersant, a leveling agent, or a cross-linking agent). A solvent may be further added at the time of the mixing as required. Alternatively, the emulsion application liquid may also be prepared by, for example, adding a liquid crystal compound, a water-dispersible resin, and any appropriate additive to a solvent, and mechanically dispersing the materials in the solvent.

The resin emulsion and the liquid crystal emulsion may each be prepared by, for example, a mechanical emulsification method, a microchannel method, or a membrane emulsification method. The liquid crystal emulsion is preferably prepared by the membrane emulsification method out of those methods. According to the membrane emulsification method, an emulsion having a uniform particle size distribution may be suitably obtained. Reference may be made to the disclosures of, for example, JP 04-355719 A and JP 2015-40994 A, which are incorporated herein by reference, for details about the membrane emulsification method.

The solid content concentration of the emulsion application liquid may be, for example, from 20 wt % to 60 wt %, preferably from 30 wt % to 50 wt %.

The release liner has a configuration in which a release agent layer is arranged on at least one surface of a film substrate. The release liner may have a sheet shape or an elongated shape. The release liner preferably has an elongated shape. As used herein, the “elongated shape” means a long and thin shape having a sufficiently long length with respect to a width and encompasses a long and thin shape having a length of, for example, 10 times or more, preferably 20 times or more with respect to a width. The film having an elongated shape can be wound into a roll shape.

The film substrate is not limited as long as the film substrate can be applied to stretching treatment described later, and a resin film is preferably used. Examples of a resin for forming the resin film include: a polyester-based resin, such as polyethylene terephthalate or polyethylene naphthalate; an acetate-based resin; a polyethersulfone-based resin; a polycarbonate-based resin; a polyamide-based resin; a polyimide-based resin; a polyolefin-based resin; a (meth)acrylic resin; a polyvinyl chloride-based resin; a polyvinylidene chloride-based resin; a polystyrene-based resin; a polyvinyl alcohol-based resin; a polyarylate-based resin; and a polyphenylene sulfide-based resin. Of those, a polyester-based resin such as polyethylene terephthalate (PET) is particularly preferred.

Examples of a material for forming the release agent layer include a silicone-based release agent, a fluorine-based release agent, a long chain alkyl-based release agent, and a fatty acid amide-based release agent. The release agents may be used alone or in combination thereof.

The thickness of the release liner is, for example, from 10 μm to 200 μm, preferably from 25 μm to 150 μm. The thickness of the release agent layer is, for example, from 0.001 μm to 10 μm, preferably from 0.03 μm to 7 μm.

The viscosity of the emulsion application liquid may be appropriately adjusted so that its application to the release liner is suitably performed. The viscosity of the emulsion application liquid at the time of the application is preferably from 20 mPa·s to 400 mPa·s, more preferably from 30 mPa·s to 300 mPa·s, still more preferably from 40 mPa·s to 200 mPa·s. When the viscosity is less than 20 mPa·s, the convection of the solvent may become remarkable at the time of the drying of the solvent to destabilize the thickness of the PDLC layer. In addition, when the viscosity is more than 400 mPa·s, the beads of the emulsion application liquid may not be stable. The viscosity of the emulsion application liquid may be measured with, for example, a rheometer MCR 302 manufactured by Anton Paar GmbH. The value of a shear viscosity under the conditions of 20° C. and a shear rate of 1,000 (1/s) is used as the viscosity in this case.

The emulsion application liquid is applied to the release agent layer surface of the release liner. Any appropriate method may be adopted as a method for the application. Examples thereof include a roll coating method, a spin coating method, a wire bar coating method, a dip coating method, a die coating method, a curtain coating method, a spray coating method, and a knife coating method (e.g., a comma coating method). Of those, a roll coating method is preferred. For example, reference may be made to the description of JP 2019-5698 A for the application by the roll coating method with a slot die.

The thickness of the applied layer is preferably from 3 μm to 40 μm, more preferably from 4 μm to 30 μm, still more preferably from 5 μm to 20 μm.

### B-2. Step II

As illustrated in FIG. 3(b), the step II includes drying the above-mentioned applied layer to form, on the release liner 40, the PDLC layer 20 including the polymer matrix 22 and the droplets 24 of the liquid crystal compound dispersed in the polymer matrix 22. Specifically, the solvent is removed from the applied layer through the drying, and the polymer matrix-forming resin particles are thus fused to each other. Thus, the PDLC layer having a structure in which the liquid crystal droplets are dispersed in the polymer matrix is formed.

The drying of the applied layer may be performed by any appropriate method. Specific examples of the drying method include natural drying, heat drying, and hot-air drying. When the emulsion application liquid contains a cross-linking agent, the cross-linked structure of the polymer matrix may be formed at the time of the drying.

A drying temperature is preferably from 20° C. to 150° C., more preferably from 25° C. to 80° C. A drying time is preferably from 1 minute to 100 minutes, more preferably from 2 minutes to 10 minutes.

Thus, a laminate having the configuration [release liner/PDLC layer] is obtained. As required, another release liner (second release liner) may be laminated on the PDLC layer side of the laminate. When the second release liner is laminated, the PDLC layer can be suitably protected until the laminate is subjected to the step III, and the laminate can be stored in a state of being wound into a roll shape. The same release liner as the release liner (first release liner) used in the step I may be used as the second release liner.

### B-3. Step III

In the step III, the PDLC layer obtained in the step II is stretched. Because of the stretching, the liquid crystal compound in each of the liquid crystal droplets is aligned in an oblique direction along the stretching direction, with the result that the PDLC layer in which the haze in the no voltage applied state has polarization dependency may be obtained.

In one embodiment, the stretching of the PDLC layer is performed by stretching the laminate of the PDLC layer 20 and the release liner 40 as illustrated in FIG. 3(c). The laminate to be stretched may have the configuration [first release liner/PDLC layer] or [second release liner/PDLC layer].

When the laminate of the PDLC layer and the release liner is stretched, the laminate may have a configuration in which an end portion of the release liner protrudes outward from an end portion of the PDLC layer. When the laminate having such configuration is subjected to stretching, the stretched PDLC layer can be formed on the release liner without impairing the appearance of the PDLC layer after the stretching. The laminate having such configuration may be obtained by, for example, applying the application liquid to the release liner while leaving the end portion of the release liner as an unapplied portion in the step I or removing the end portion of the PDLC layer formed on the release liner in the step II through use of a pressure-sensitive adhesive tape.

In another embodiment, the stretching of the PDLC layer is performed by peeling the PDLC layer from the release liner and stretching the PDLC layer alone. In this embodiment, the PDLC layer is subjected to stretching after being peeled (picked up) from the release liner through use of a pressure-sensitive adhesive tape or the like.

There is no limitation on the stretching direction of the PDLC layer. For example, when the PDLC layer or the laminate has an elongated shape, the stretching direction may be a lengthwise direction, a widthwise direction, or an oblique direction. Examples of a method for the stretching include free end stretching, fixed end stretching, and a combination thereof.

The stretching ratio may be appropriately set in accordance with the polarization dependency of a haze desired for the PDLC film, the birefringence of the liquid crystal compound, and the like. In general, when the stretching ratio is large, the polarization dependency tends to be large (in other words, the amount of change in haze caused by a change in vibration direction of incident linearly polarized light tends to be large). When the stretching ratio is too small, sufficient polarization dependency of the haze may not be obtained. In addition, when the stretching ratio is too large, the PDLC layer may be broken. The stretching ratio is, for example, more than 1.0 times and 5 times or less, preferably from 1.1 times to 3 times, more preferably from 1.1 times to 2 times.

A stretching temperature is, for example, the glass transition temperature (Tg) of the polymer matrix-forming resin)−50° C. to Tg+50° C., preferably from Tg−20° C. to Tg+20° C.

When the PDLC layer is stretched alone, the PDLC layer after the stretching may be directly subjected to the step IV, or may be bonded to another release liner (third release liner) and subjected to the step IV as a laminate having the configuration [third release liner/PDLC layer]. In addition, when the PDLC layer is stretched in a state of a laminate with the release liner, the PDLC layer after the stretching may be transferred to the third release liner and subjected to the step IV in a state of [third release liner/PDLC layer]. The same release liner as the first release liner may be used as the third release liner.

### B-4. Step IV

In the step IV, a laminate of the PDLC layer after the stretching and the first transparent conductive film is obtained. When the PDLC layer is subjected to the step IV in a state of a laminate with the release liner, the PDLC layer 20 is transferred from the release liner 40 to the first transparent conductive film 10 as illustrated in FIG. 3(d) and FIG. 3(e). Thus, a laminate having the configuration [first transparent conductive film/PDLC layer] is obtained.

The lamination (transfer) of the PDLC layer on (to) the first transparent conductive film may be performed via an adhesion layer or may be performed without via the adhesion layer.

The first transparent conductive film is as described in the section A-1. Typically, the PDLC layer is laminated on the first transparent electrode layer side of the first transparent conductive film.

### B-5. Step V

In the step V, as illustrated in FIG. 3(f), in the above-mentioned laminate, the second transparent conductive film 30 is laminated on the PDLC layer 20 on the opposite side to the side on which the first transparent conductive film 10 is arranged. The second transparent conductive film is as described in the section A-2. Typically, the second transparent conductive film is laminated so that the surface on the second transparent electrode layer side faces the PDLC layer. Thus, a PDLC film having the configuration [first transparent conductive film/PDLC layer/second transparent conductive film] is obtained.

The lamination of the second transparent conductive film on the PDLC layer may be performed via an adhesion layer or may be performed without via the adhesion layer.

From the viewpoint of obtaining sufficient adhesiveness, the lamination of the second transparent conductive film may be performed while preferably a lamination pressure of from 0.006 MPa/m to 7 MPa/m, more preferably a lamination pressure of from 0.06 MPa/m to 0.7 MPa/m is applied with a laminator.

When the first transparent conductive film and/or the second transparent conductive film is optically anisotropic and has a slow axis, the polarization dependency of the haze at the time when linearly polarized light is caused to enter the PDLC film can be maximized by performing lamination so that the slow axis direction of the transparent conductive film to be arranged on an incident side and the stretching direction of the PDLC layer are perpendicular or parallel to each other.

### C. Optical Film Set

An optical film set according to an embodiment of the present invention includes the PDLC film described in the section A and a polarizer arranged on one side thereof. The polarizer is arranged on one side of the PDLC film so as to be able to change the polarization state of light caused to enter the PDLC film or the vibration direction of linearly polarized light caused to enter the PDLC film. For example, the polarizer may be arranged on one side of the PDLC film in a removable manner so that linearly polarized light or non-polarized light can be caused to enter the PDLC film. In addition, for example, the polarizer may be arranged on one side of the PDLC film in a rotatable manner in a plane parallel to the main surface of the PDLC film so that linearly polarized light vibrating in various directions can be caused to enter the PDLC film.

The polarizer preferably exhibits absorption dichroism at any one of wavelengths of from 380 nm to 780 nm. The single layer transmittance of the polarizer is preferably from 38.6% to 46.0%, more preferably from 40.0% to 46.0%. The degree of polarization of the polarizer is preferably 97.0% or more, more preferably 99.0% or more. The polarizer is typically formed of a polyvinyl alcohol-based resin film containing a dichroic substance (e.g., iodine).

### Examples

The present invention is specifically described below by way of Examples. However, the present invention is by no means limited to these Examples. Measurement methods for characteristics are as described below. In addition, unless otherwise specified, “part(s)” and in Examples and Comparative Example are by weight.

### (1) Thickness

Measurement was performed with a digital micrometer (manufactured by Anritsu Corporation, product name: “KC-351C”).

### (2) Volume-Average Particle Diameter of Liquid Crystal Particles in Liquid Crystal Emulsion

0.1 Weight percent of a liquid crystal emulsion was added to 200 ml of an electrolyte aqueous solution (manufactured by Beckman Coulter, Inc., “Isoton II”), and the resultant mixed liquid was used as a measurement sample. The particle diameters of the liquid crystal particles in the sample were measured with Multisizer 3 (manufactured by Beckman Coulter, Inc., aperture size=20 μm), and the statistics of volumes were collected for each discretized particle diameter by dividing the measured values into 256 sections arranged at equal intervals in the range of from 0.4 μm to 12 μm on a logarithmic scale, followed by the calculation of the volume-average particle diameter of the particles. When particles each having a particle diameter of 12 μm or more were present, the volume-average particle diameter was calculated by: setting the aperture size to 30 μm; and dividing the measured values into 256 sections arranged at equal intervals in the range of from 0.6 μm to 18 μm on a logarithmic scale to collect the statistics of volumes for each discretized particle diameter.

### (3) Average Particle Diameter of Resin Particles

Several droplets of a resin dispersion were added to 100 ml of water to prepare a measurement sample. The measurement sample was set in the measurement holder of a dynamic light scattering-type particle diameter distribution-measuring apparatus (manufactured by Microtrac Retsch GmbH, apparatus name: “Nanotrac 150”), and the fact that the concentration of the measurement sample was measurable was recognized with the monitor of the apparatus, followed by the measurement of the average particle diameter of the resin particles with the apparatus.

### (4) Haze

Measurement was performed with a product available under the product name “NDH 4000” from Nippon Denshoku Industries Co., Ltd. in accordance with JIS K 7136.

### Example 1-1

### (First and Second Transparent Conductive Films)

An ITO layer was formed on one surface of a cycloolefin resin substrate (thickness: 40 μm, Re(550): 3 nm) by a sputtering method to provide a transparent conductive film (haze: about 8%) having the configuration [transparent substrate/transparent electrode layer].

### (Production of Emulsion Application Liquid)

58.8 Parts of a liquid crystal compound (manufactured by JNC Corporation, product name: “LX-153XX”, birefringence Δn=0.149 (ne=1.651, no=1.502), viscosity=48.5 mPa·s), 40 parts of pure water, and 1.2 parts of a dispersant (manufactured by DKS Co. Ltd., product name: “NOIGEN ET159”) were mixed, and the mixture was stirred with a homogenizer at 100 rpm for 10 minutes to prepare a liquid crystal emulsion. The average particle diameter of liquid crystal particles in the resultant liquid crystal emulsion was 3.5 μm.

31.72 Parts of the above-mentioned liquid crystal emulsion, 11.65 parts of a polyether-based polyurethane resin aqueous dispersion (manufactured by DSM JAPAN K.K., product name: “NeoRez R967”, polymer average particle diameter: 80 nm, CV value=0.27, solid content: 40 wt %), 31.09 parts of an acrylic resin aqueous dispersion (manufactured by DIC Corporation, product name: “BURNOCK WE-314”, polymer average particle diameter: 140 nm, CV value=0.25, solid content: 45 wt %), 0.02 part of a leveling agent (manufactured by DIC Corporation, product name: “F-444”), 1.35 parts of a cross-linking agent (propylidynetrimethyl tris [3-(2-methylaziridin-1-yl)propionate]), and 24.17 parts of pure water were mixed to provide an emulsion application liquid (solid content concentration: 40 wt %).

### (Application of Emulsion Application Liquid and Formation of PDLC Layer)

The above-mentioned emulsion application liquid was applied to the release agent layer surface of a first release liner (manufactured by Mitsubishi Chemical Corporation, product name: “MRF38”) to form an applied layer. The application was performed with a wire bar (model No. “OSP25”).

The applied layer was dried at 25° C. for 60 minutes to form a PDLC layer having a thickness of 6.96 μm on the release liner.

Then, a second release liner (manufactured by Mitsubishi Chemical Corporation, product name: “MRF38”) was laminated on the PDLC layer to provide a laminate having the configuration [first release liner/PDLC layer/second release liner].

### (Stretching of PDLC Layer)

The second release liner was peeled from the above-mentioned laminate. The PDLC layer thus exposed was lifted up with a Kapton tape to be peeled from the first release liner, and was subjected to fixed end stretching by 1.1 times at 25° C. while both end portions thereof were held with tenter clips. The thickness of the PDLC layer after the stretching (stretched PDLC layer) was 4.99 μm.

The stretched PDLC layer was bonded onto a third release liner (manufactured by Mitsubishi Chemical Polyester Film Co., Ltd., product name: “MRF38”) to provide a laminate having the configuration [third release liner/stretched PDLC layer].

### (Lamination of First Transparent Conductive Film)

The first transparent conductive film was laminated on the stretched PDLC layer side of the above-mentioned laminate while a lamination pressure of 0.4 MPa/m was applied with a laminator, and then the third release liner was peeled. Thus, the PDLC layer was transferred to the first transparent conductive film. The transfer was performed so that the ITO layer faced the stretched PDLC layer r and no adhesion layer was interposed therebetween. Thus, a laminate having the configuration [first transparent conductive film/stretched PDLC layer] was obtained.

### (Lamination of Second Transparent Conductive Film)

The second transparent conductive film was laminated on the stretched PDLC layer side of the above-mentioned laminate while a lamination pressure of 0.4 MPa/m was applied with a laminator. The lamination was performed so that the ITO layer faced the stretched PDLC layer and no adhesion layer was interposed therebetween. Thus, a PDLC film having the configuration [first transparent conductive film/stretched PDLC layer/second transparent conductive film] was obtained.

### Example 1-2

A PDLC film was obtained in the same manner as in Example 1-1 except that the stretching ratio of the PDLC layer was set to 1.5 times. The thickness of the stretched PDLC layer was 4.55 μm.

### Example 1-3

A PDLC film was obtained in the same manner as in Example 1-1 except that the stretching ratio of the PDLC layer was set to 2.0 times. The thickness of the stretched PDLC layer was 3.91 μm.

### Comparative Example 1

A PDLC film was obtained in the same manner as in Example 1-1 except that the stretching of the PDLC layer was not performed. The thickness of the PDLC layer was 6.96 μm.

### Example 2-1

A PDLC film was obtained in the same manner as in Example 1-1 except that the application liquid was applied with a wire bar (model No. “OSP52”) to form a PDLC layer having a thickness of 17.07 μm. The thickness of the resultant stretched PDLC layer was 14.56 μm.

### Example 2-2

A PDLC film was obtained in the same manner as in Example 2-1 except that the stretching ratio of the PDLC layer was set to 1.5 times. The thickness of the stretched PDLC layer was 12.16 μm.

### Example 2-3

A PDLC film was obtained in the same manner as in Example 2-1 except that the stretching ratio of the PDLC layer was set to 2.0 times. The thickness of the stretched PDLC layer was 9.03 μm.

### Comparative Example 2

A PDLC film was obtained in the same manner as in Example 2-1 except that the stretching of the PDLC layer was not performed. The thickness of the PDLC layer was 17.07 μm.

### Example 3-1

A PDLC film was obtained in the same manner as in Example 1-1 except that the application liquid was applied with a wire bar (model No. “OSP80”) to form a PDLC layer having a thickness of 24.39 μm. The thickness of the resultant stretched PDLC layer was 23.38 μm.

### Example 3-2

A PDLC film was obtained in the same manner as in Example 3-1 except that the stretching ratio of the PDLC layer was set to 1.5 times. The thickness of the stretched PDLC layer was 16.49 μm.

### Example 3-3

A PDLC film was obtained in the same manner as in Example 3-1 except that the stretching ratio of the PDLC layer was set to 2.0 times. The thickness of the stretched PDLC layer was 13.95 μm.

### Comparative Example 3

A PDLC film was obtained in the same manner as in Example 3-1 except that the stretching of the PDLC layer was not performed. The thickness of the PDLC layer was 24.39 μm.

### <Optical Microscope Observation>

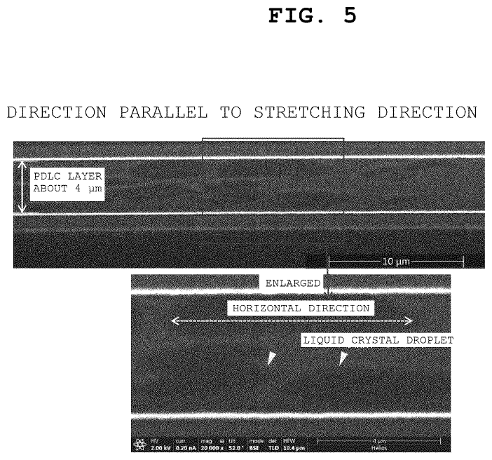

The main surfaces of the PDLC films obtained in Examples and Comparative Examples were each observed with an optical microscope (reflected light observation). The observed images are shown in FIG. 4.

As shown in FIG. 4, in the observed image of each of the PDLC films, the liquid crystal droplets dispersed in the polymer matrix were recognized, and the liquid crystal droplets of the PDLC films of Examples each had an elliptical shape with the stretching direction being a major axis direction.

### <Sectional SEM Observation>

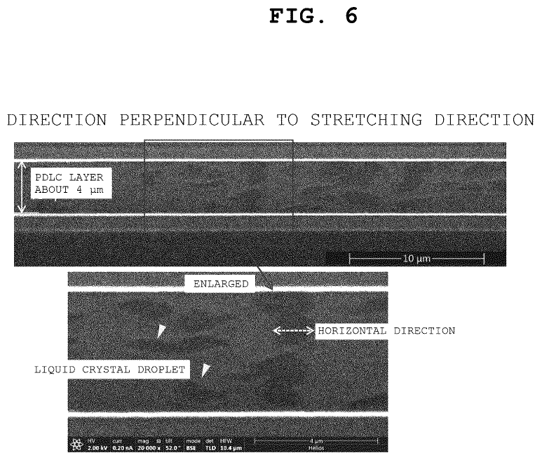

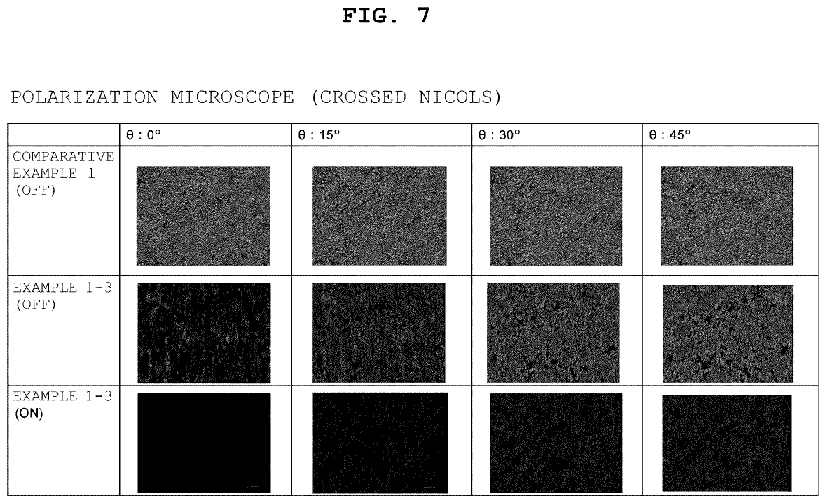

A cut surface obtained by cutting the PDLC film obtained in Example 1-3 in a direction parallel or perpendicular to the stretching direction was observed with a scanning electron microscope (SEM). The observed images are shown in FIG. 5 and FIG. 6.

As shown in FIG. 5 and FIG. 6, the liquid crystal droplets on the cut surface parallel to the stretching direction each had an elliptical shape with the horizontal direction being a major axis direction, and the length in the horizontal direction was several micrometers. Meanwhile, the liquid crystal droplets on the cut surface perpendicular to the stretching direction each had a circular shape or an elliptical shape with the horizontal direction being a major axis direction, and the length in the horizontal direction was from several hundred nanometers to several micrometers. It is understood from FIG. 4 to FIG. 6 that the liquid crystal droplets in the stretched PDLC layer each have a flat shape with the stretching direction being a major axis direction.

### <Polarization Microscope Observation>

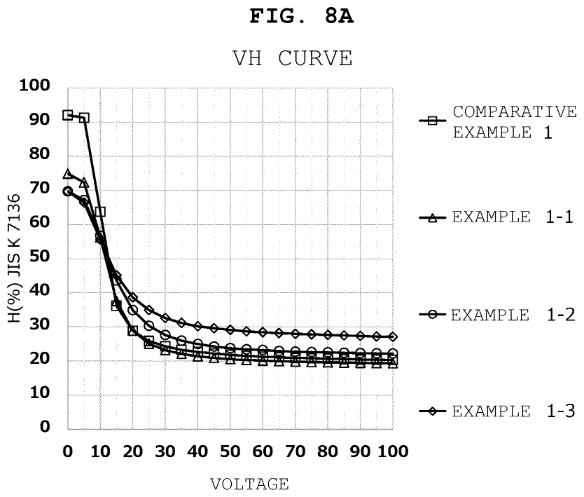

The PDLC films obtained in Example 1-3 in a voltage applied state (50 V) and in a no voltage applied state (OFF) and the PDLC film obtained in Comparative Example 1 in a no voltage applied state (OFF) were each observed with a polarization microscope including two polarizers arranged in crossed Nicols while the observation angle was changed. The observed images are shown in FIG. 7. In the figure, θ represents an angle formed by the absorption axis direction of the polarizer on the light source side and the stretching direction of the PDLC film.

As shown in FIG. 7, the transmittance of the PDLC film of Example 1-3 became larger as the angle θ became larger, and this tendency was conspicuous under the no voltage applied state. From the foregoing, it is understood that the PDLC film of Example 1-3 exhibits dichroism. Regarding the PDLC film of Comparative Example 1, no change in transmittance was recognized even when the observation angle was changed. Thus, it is understood that, in the PDLC film of Example 1-3, the liquid crystal compound is aligned in the stretching direction under the no voltage applied state and is aligned in an electric field direction (direction perpendicular to the main surface) by the application of a voltage. It is also understood that, in the PDLC film of Comparative Example 1, the liquid crystal compound is in a non-aligned state under the no voltage applied state.

### <Haze Polarization Dependency Evaluation 1>

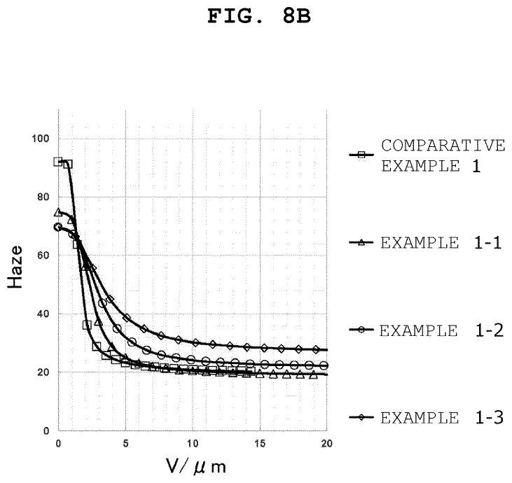

An AC voltage of from 0 V to 100 V (rectangular AC of 60 Hz) was applied to each of the PDLC films obtained in Examples 1-1 to 1-3 and Comparative Example 1 under a state in which light from a power source emitting non-polarized light was caused to enter the main surface thereof perpendicularly. A haze in this case was measured. A relationship (VH curve) between the measured haze and the applied voltage and a relationship between the haze and the voltage per unit thickness are shown in FIG. 8A and FIG. 8B, respectively.

As shown in FIG. 8A and FIG. 8B, when non-polarized light was caused to enter the PDLC film under a no voltage applied state, each of the PDLC films of Examples 1-1 to 1-3 including the stretched PDLC layer exhibited a haze lower than that of the PDLC film of Comparative Example 1 including the unstretched PDLC layer.

### <Haze Polarization Dependency Evaluation 2>

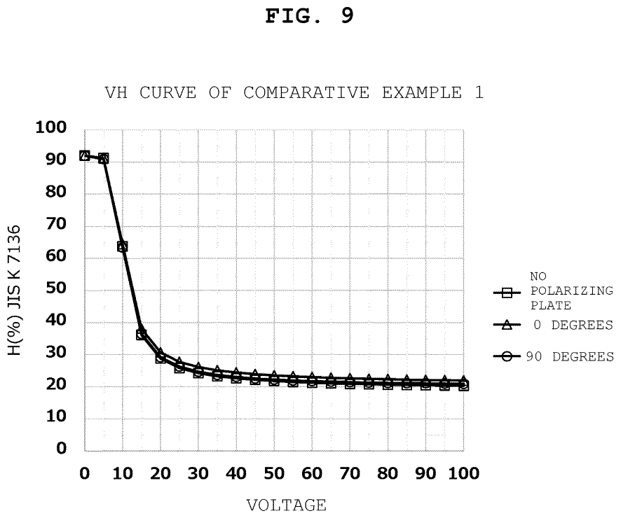

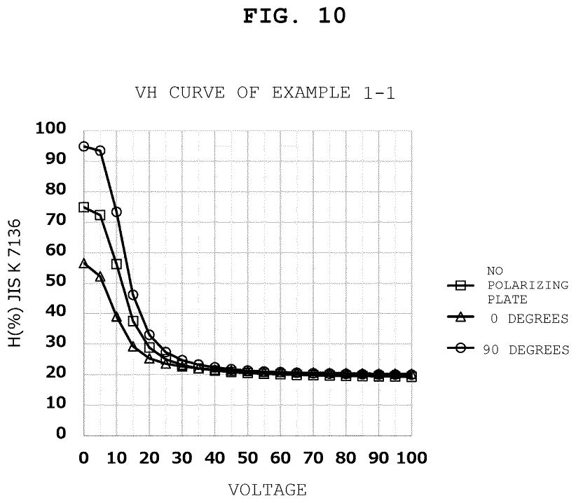

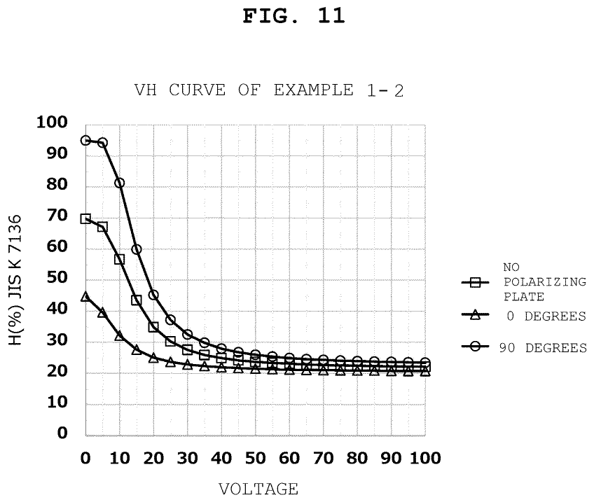

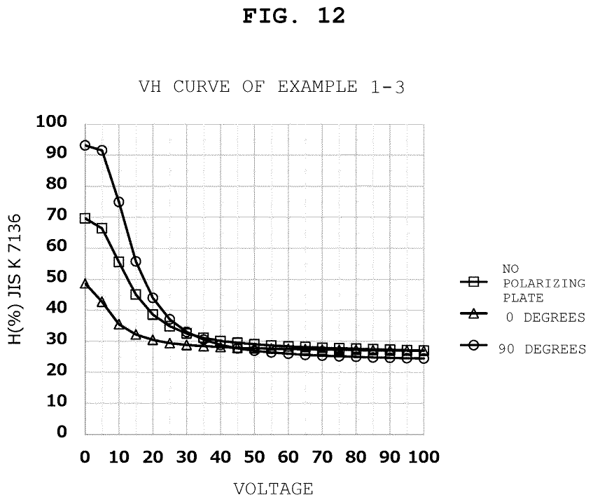

An AC voltage of from 0 V to 100 V (rectangular AC of 60 Hz) was applied to each of the PDLC films obtained in Examples 1-1 to 1-3 and Comparative Example 1 under a state in which light from a power source emitting non-polarized light was caused to enter the main surface thereof perpendicularly through a polarizing plate or without through the polarizing plate. A haze in this case was measured. The measurement of the haze through the polarizing plate was performed by arranging the PDLC film so that the absorption axis direction of the polarizing plate was parallel (0 degrees) or perpendicular (90 degrees) to the stretching direction of the PDLC layer. A relationship (VH curve) between the measured haze and the applied voltage is shown in FIG. 9 to FIG. 12.

As shown in FIG. 9 to FIG. 12, in each of the PDLC films obtained in Examples, when linearly polarized light was caused to enter the PDLC film perpendicularly to the main surface thereof under a no voltage applied state, the haze varied depending on the vibration direction of the linearly polarized light. Specifically, the haze at the time when the vibration direction of the linearly polarized light was parallel to the stretching direction of the PDLC layer was larger than the haze at the time when the vibration direction of the linearly polarized light was perpendicular to the stretching direction of the PDLC layer. In addition, the haze at the time when non-polarized light was caused to enter the PDLC film was an intermediate value therebetween. Meanwhile, in the PDLC film obtained in Comparative Example, no substantial change in haze was recognized when light in a different polarized state was caused to enter the PDLC film.

### INDUSTRIAL APPLICABILITY

The PDLC film of the present invention may be suitably used in various applications including display bodies, such as an advertisement and a guide board, and a smart window.

### REFERENCE SIGNS LIST

100 PDLC film
10 first transparent conductive film
20 PDLC layer
22 polymer matrix
24 liquid crystal droplet
30 second transparent conductive film

1. A polymer dispersed liquid crystal film, comprising in this order:
a first transparent conductive film;
a polymer dispersed liquid crystal layer including a polymer matrix and droplets of a liquid crystal compound dispersed in the polymer matrix; and
a second transparent conductive film,
wherein the polymer dispersed liquid crystal film exhibits a lower haze under a voltage applied state than under a no voltage applied state, and
wherein the haze in the no voltage applied state exhibits polarization dependency.

2. The polymer dispersed liquid crystal film according to claim 1, wherein, under the no voltage applied state, a maximum value of a difference between a haze at a time when linearly polarized light vibrating in a first direction is caused to enter the polymer dispersed liquid crystal film perpendicularly to a main surface thereof and a haze at a time when linearly polarized light vibrating in a second direction perpendicular to the first direction is caused to enter the polymer dispersed liquid crystal film perpendicularly to the main surface is 10% or more.

3. The polymer dispersed liquid crystal film according to claim 1, wherein the liquid crystal compound includes a nematic liquid crystal compound.

4. The polymer dispersed liquid crystal film according to claim 1, wherein a polymer matrix-forming resin for forming the polymer matrix includes at least one kind selected from a urethane-based resin, an acrylic resin, and a polyvinyl alcohol-based resin.

5. An optical film set, comprising:
the polymer dispersed liquid crystal film of claim 1; and
a polarizer arranged on one side of the polymer dispersed liquid crystal film.

6. A method of producing a polymer dispersed liquid crystal film, comprising in this order:
applying, to a surface of a release liner, an application liquid containing a liquid crystal compound, a polymer matrix-forming resin, and a solvent to form an applied layer;
drying the applied layer to form a polymer dispersed liquid crystal layer including a polymer matrix and droplets of the liquid crystal compound dispersed in the polymer matrix on the release liner;
stretching the polymer dispersed liquid crystal layer;
obtaining a laminate of the polymer dispersed liquid crystal layer and a first transparent conductive film; and
laminating a second transparent conductive film on the polymer dispersed liquid crystal layer on an opposite side to a side on which the first transparent conductive film is arranged.

7. The method of producing a polymer dispersed liquid crystal film according to claim 6, wherein a stretching ratio of the polymer dispersed liquid crystal layer is more than 1.0 times and 5 times or less.

8. The method of producing a polymer dispersed liquid crystal film according to claim 6, wherein the liquid crystal compound includes a nematic liquid crystal compound.

9. The method of producing a polymer dispersed liquid crystal film according to claim 6, wherein a polymer matrix-forming resin for forming the polymer matrix includes at least one kind selected from a urethane-based resin, an acrylic resin, and a polyvinyl alcohol-based resin.
